(19) United States
(12) Patent Application Publication
(10) Pub. No.: US 2007/0056813 A1
(43) Pub. Date: Mar. 15, 2007

(54) Hysteresis brake for a valve operating control device of an internal combustion engine

(76) Inventors: Andreas Eichenberg, Chemnitz (DE); Matthias Gregor, Stuttgart (DE); Jens Meintschel, Esslingen (DE)

Correspondence Address: KLAUS J. BACH, 4407 TWIN OAKS DRIVE, MURRYSVILLE, PA, 15668, US

(21) Appl. No.: 11/584,335

(22) Filed: Oct. 20, 2006

Related U.S. Application Data
(63) Continuation-in-part of application No. PCT/EP05/03809, filed on Apr. 12, 2005.

(30) Foreign Application Priority Data
Apr. 20, 2004 (DE) 10 2004 018 946.3

(51) Int. Cl. H02K 7/10; H02P 15/00

(52) U.S. Cl. 188/158; 188/161; 310/77; 310/93

(57) ABSTRACT

In a valve operating control device hysteresis brake particularly for a valve drive of an internal combustion engine, including a hysteresis device rotatable about an axis of rotation so as to be movable along a pole structure of an electromagnet forming a magnetic field effect region in the hysteresis device along the pole structure, a compact and high-performance arrangement is provided for the hysteresis device by an offset in the axial and/or radial direction providing at least two magnetic field effect regions in which the hysteresis device is movably supported.

This is a Continuation-In-Part Application of pending International patent application PCT/EP2005/003809 filed Apr. 12, 2005 and claiming the priority of German application 10 2004 018 946.3 filed Apr. 20, 2004.

### BACKGROUND OF THE INVENTION

The invention relates to a hysteresis brake comprising a hysteresis device, particularly a valve operating control device hysteresis brake of an internal combustion engine.

The phase angle of a camshaft relative to a crankshaft can be altered by passive, i.e. driveless, camshaft adjusters. It is known for this purpose to use hysteresis brakes functioning in a contact-free and wear-free manner. In a hysteresis brake such as this, a magnetically semi-hard hysteresis element moving in a pole structure of an electromagnet is braked by means of constant remagnetization. Magnetically semi-hard is understood to mean that the material has a pronounced hysteresis loop in the flux density/magnetic field (B/H) graph.

The laid-open specification DE 103 24 45 A1 discloses a hysteresis brake for a valve control device for an internal combustion engine which has a hysteresis element rotating in the circumferential direction within a stator. The stator is formed from two concentrically arranged stator parts, which have mutually opposite rows of pole teeth, the pole teeth of one stator part in each case pointing into gaps between pole teeth of the other stator part. The hysteresis strip rotates between the rows of pole teeth of the two stator parts and is braked by means of remagnetization. One problem associated with such hysteresis brakes is their size and their high weight, which is particularly unfavorable in the case of conventionally very tight spatial conditions in motor vehicles.

It is the principal object of the present invention to provide a compact hysteresis brake with an improved moment so that it is suitable in particular as a valve operating control hysteresis brake.

### SUMMARY OF THE INVENTION

In a valve operating control device hysteresis brake particularly for a valve drive of an internal combustion engine, including a hysteresis device rotatable about an axis of rotation so as to be movable along a pole structure of an electromagnet forming a magnetic field effect region in the hysteresis device along the pole structure, a compact and high-performance arrangement is provided for the hysteresis device by an offset in the axial and/or radial direction providing at least two magnetic field effect regions in which the hysteresis device is movably supported.

The hysteresis brake according to the invention is particularly suitable as a valve control device hysteresis brake of an internal combustion engine as it is relatively small but capable of providing a high control torque. It has at least two magnetic field effect regions, which are spaced apart in the axial and/or radial direction. A magnetic field effect region is in this case a region of the hysteresis device which is subjected to magnetic flux by magnetic poles of the stator or of stator parts or permeated by magnetic flux. As a result of such a multiple use of the magnetic flux in the stator, an improved braking moment is achieved given the same physical size in comparison with a conventional hysteresis brake. Accordingly, it is alternatively possible to achieve a reduction in the physical size and weight owing to the multiple magnetization of the hysteresis device in the same magnetic circuit, with the result that the physical size and weight can be reduced given the same braking moment. The hysteresis device can be integral with a hysteresis element or else have a multi-part design with a plurality of hysteresis elements. The magnetic flux in the magnetic circuit is virtually constant or increases only to a small extent irrespective of the number of hysteresis elements contained in the magnetic circuit that is the consumption of electrical power of a coil which induces the magnetic field is essentially independent of the number of hysteresis elements. Two or more hysteresis elements in the form of strips or disks can rotate in the common magnetic circuit of the stator which is magnetically excited by the electric coil. The pole structure provided in the stator for each hysteresis element is preferably one which in each case brings about a magnetic field effect region in the hysteresis element. While the magnetic flux is constant in the magnetic circuit, a braking moment is exerted on each of the rotating hysteresis elements of the hysteresis device because of the re-magnetization which takes place. A comparable effect occurs if multiple magnetization of only one hysteresis element in the form of a strip or a disk is provided.

The magnetic field effect regions are preferably each generated by the pole structure of a common, multi-part stator. This allows for an advantageously compact design. An electrical coil for magnetically exciting the stator or the hysteresis element may be integrated in the stator in a space-saving manner. However, arrangements are also conceivable which include a plurality of stators and hysteresis devices. The stator may comprise concentrically arranged stator parts or coaxially arranged stator parts.

If the hysteresis device comprises a magnetic body in the form of a strip, magnetization of the hysteresis device can take place in the radial direction or else in the circumferential direction, depending on the pole structure used. If the poles of the stator parts are offset with respect to one another, the magnetization is in the circumferential direction, whereas if they are opposite one another, the magnetization has a radial orientation.

In the generally known prior art, the hysteresis device has a strip which can rotate in the circumferential direction within the stator. The hysteresis device in the process rotates about an axis of rotation, which is also the axis of symmetry of the stator.

In a first advantageous embodiment, the hysteresis device includes two strips, which are axially offset in relation to its axis of rotation and can rotate in the circumferential direction within the stator.

In a further advantageous embodiment, the hysteresis device includes two strips, which are radially offset in relation to its axis of rotation and can rotate in the circumferential direction within the stator.

The strip or strips is or are magnetized in the radial direction in relation to their axis of rotation.

If a plurality of strips is provided, these strips can be arranged on a common rotatable carrier. However, it is also conceivable for the strips each to be arranged on a separate carrier.

In an advantageous alternative embodiment, the hysteresis device comprises a disk-shaped magnetic body. In this case, the hysteresis device has at least one disk which can rotate within the stator.

Preferably, the hysteresis device has two axially offset disks which can rotate within the stator. In this arrangement, the mechanical moment of inertia is less than in the case of a radial arrangement, and the utilization of the magnetic flux is improved and the braking moment is improved given the same electrical power consumption.

The disk or disks is or are preferably magnetized in the circumferential direction in relation to their axis of rotation.

The number of hysteresis elements in the hysteresis device in the form of strips or disks can be increased to three or even any desired number. A combination of all or individual ones of the described refinements in a single magnetic circuit is also conceivable.

Exemplary embodiments of the invention will be explained in more detail below with reference to the accompanying drawings.

### BRIEF DESCRIPTION OF THE DRAWINGS

FIGS. 1a, 1b, and 1c show a simplified illustration of a magnetic circuit of a preferred hysteresis brake in accordance with the invention (a) and a conventional hysteresis brake (b and c) as well as a detail of a distribution of the lines of force of the conventional hysteresis brake.

FIGS. 2a and 2b show a preferred arrangement with coaxially arranged stator parts (2a) and a sectional illustration with magnetization in the circumferential direction (2b),

FIGS. 3a and 3b show a preferred arrangement with concentrically arranged stator parts (3a) and a sectional illustration with radial magnetization (3b),

FIGS. 4a and 4b show a simplified illustration of a magnetic circuit with a multi-part hysteresis device (4a) and a sectional illustration of a preferred refinement with pot-shaped hysteresis elements (4b) which are axially spaced apart,

FIG. 5 shows a sectional illustration with a multi-part hysteresis device magnetized in the radial direction with axially spaced-apart hysteresis elements,

FIG. 6 shows a sectional illustration with a multi-part hysteresis device magnetized in the radial direction with radially spaced-apart hysteresis elements, and

FIG. 7 shows a sectional illustration of a preferred hysteresis brake with two disks, which are magnetized in the circumferential direction, of a hysteresis device.

### DESCRIPTION OF PARTICULAR EMBODIMENTS

Parts which essentially are the same or functionally correspond to one another are provided with the same reference symbols in the figures.

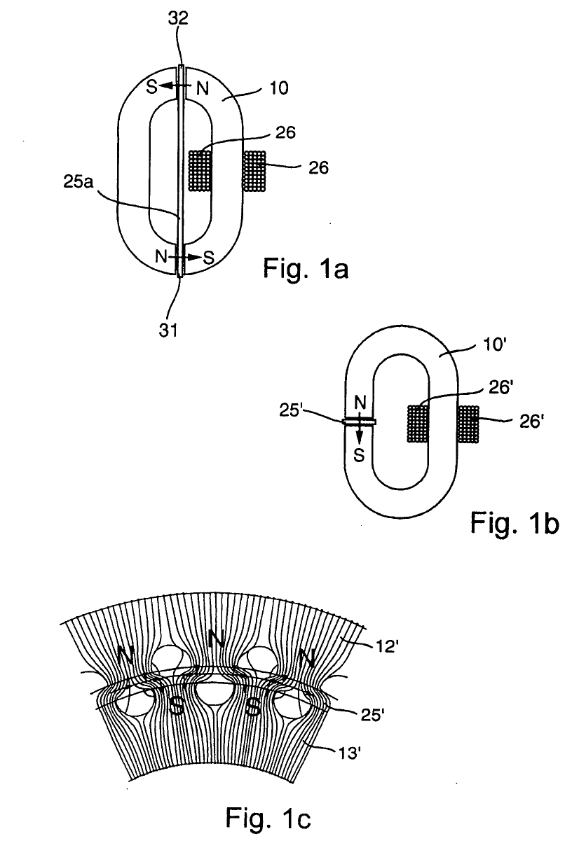

FIGS. 1a-1c show a simplified illustration of a magnetic circuit of a preferred hysteresis brake in accordance with the invention (FIG. 1a) and a conventional hysteresis brake (FIG. 1b) and a distribution of the lines of force of the magnetic flux (FIG. 1c). In the case of the conventional hysteresis brake, as is known from DE 103 24 45 A1, a magnetically semi-hard material in the form of a hysteresis device 25′, in the form of a strip, is arranged in a magnetic circuit between two concentrically arranged stator parts 12′, 13′. The magnetic circuit is electrically excited by a coil 26′. Owing to the poles N, S of the two stator parts 12′, 13′, which poles are each offset with respect to one another, the magnetic flux flowing through each pole is split into two parts and must pass tangentially through the strip lying between the poles in the circumferential direction on the path from the outer stator part 12′ to the inner stator part 13′. In the process, the hysteresis device 25′ is correspondingly remagnetized, and a magnetic effect region is formed in the effect region of the poles in the hysteresis device 25′. The hysteresis device 25′ is connected to a camshaft (not illustrated), particularly via an actuating mechanism for adjusting a phase angle of the camshaft relative to a crankshaft of an internal combustion engine which drives the camshaft. In order to control the adjustment, the coil 26 is energized so as to bring about a desired braking moment. Details in this regard are not illustrated but are familiar to a person skilled in the art.

The directions of the two partial flows originating from a single pole are ideally different by 180° (FIG. 1c). If the strip is now rotated further, for example in the case of a rotation through one tooth, for example from the north pole N to the south pole S, of the pole structure, magnetic flux passes through the point through which magnetic flux has just passed, precisely in the opposite direction. As a result, the strip is magnetized in the opposite direction. The work carried out in the process corresponds to the area of the hysteresis loop in the B/H graph and is referred to as remagnetization work.

The hysteresis device 25, which has different designs in the figures, is denoted by the same reference symbols, but is additionally identified by the suffix of a letter in order to distinguish between the individual exemplary embodiments.

The preferred refinement shown in FIG. 1a shows a stator 10, which is arranged in two parts and in the case of which a hysteresis device 25a can be moved between two pole structures produced as a result of the division, which hysteresis device may be in the form of a disk or a strip. The hysteresis device 25a is in this case magnetized twice and forms two magnetic field effect regions 31, 32, which are spaced apart from one another, in relation to the upper and lower pole structures shown in the figure. The magnetic field effect regions 31, 32 are each caused by the pole structure or pole structures 33 of a common, multi-part stator 11.

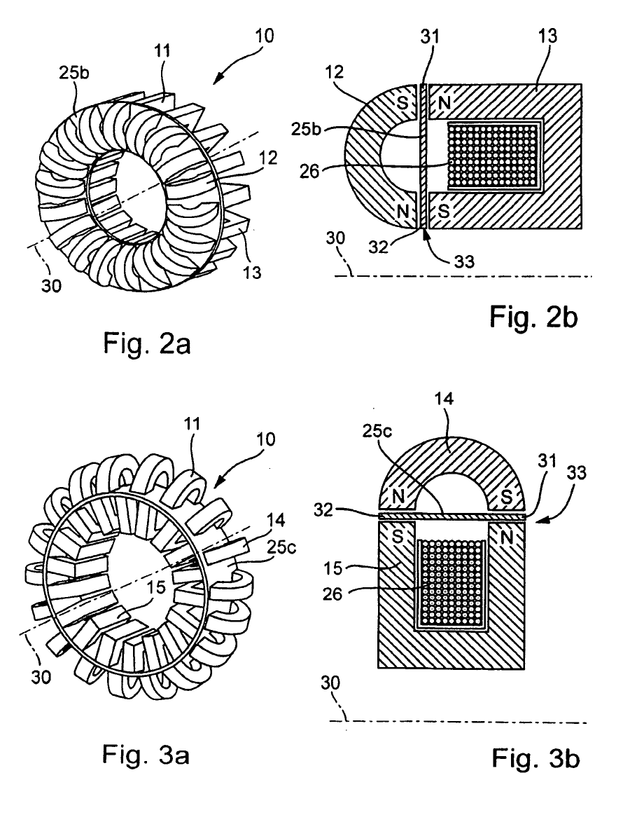

FIGS. 2a and 2b show a preferred arrangement with coaxially arranged stator parts 12, 13 (FIG. 2a) and a sectional illustration with magnetization in the circumferential direction (FIG. 2b), a hysteresis device 25b in the form of a disk rotating about an axis of rotation 30 between the stator parts 12, 13, which are arranged offset with respect to their pole teeth. A coil 26 is arranged in the inner stator part 13 in order to magnetically excite the arrangement. Solid yokes, magnetically conductive rods or else laminate stacks can be used as the stator parts 14, 15. The hysteresis device 25b in the form of a disk is permeated in the circumferential direction by the magnetic flux twice in different directions to form magnetic field effect regions 31, 32. The magnetization takes place at different radii of the hysteresis device 25b in the form of a disk. As a result of the double magnetization, the magnetic flux is used twice and the braking effect is increased. The hysteresis brake is smaller than prior art designs given the same braking moment.

A preferred embodiment of a hysteresis brake 10 having concentrically arranged stator parts of a common stator 11 is illustrated in FIGS. 3a, 3b in a schematic view (FIG. 3a) and as a sectional illustration (FIG. 3b). An inner and an outer stator part 14, 15 are arranged concentrically with respect to one another. A coil 26 is arranged in the inner stator part 15. A hysteresis element in the form of a strip of a hysteresis device 25c rotates about an axis of rotation 30 between the two stator parts 14, 15, which are arranged offset in the circumferential direction in relation to their pole teeth, the hysteresis device 25c being magnetized radially alternately once from the outside towards the inside and once from the inside towards the outside. The stator parts 14, 15 have the described pole structure in the direction of the strip. An arrangement with separate, magnetic rods or preferably laminate stacks, which can replace solid yokes with the pole structure 33, is also conceivable. Because of the double magnetization, the magnetic flux is utilized more effectively. It is also possible to split the strip into two strips such that a dedicated strip of the hysteresis device 25c rotates in each pole structure 33. The hysteresis brake 10 is relatively smaller given the same braking moment.

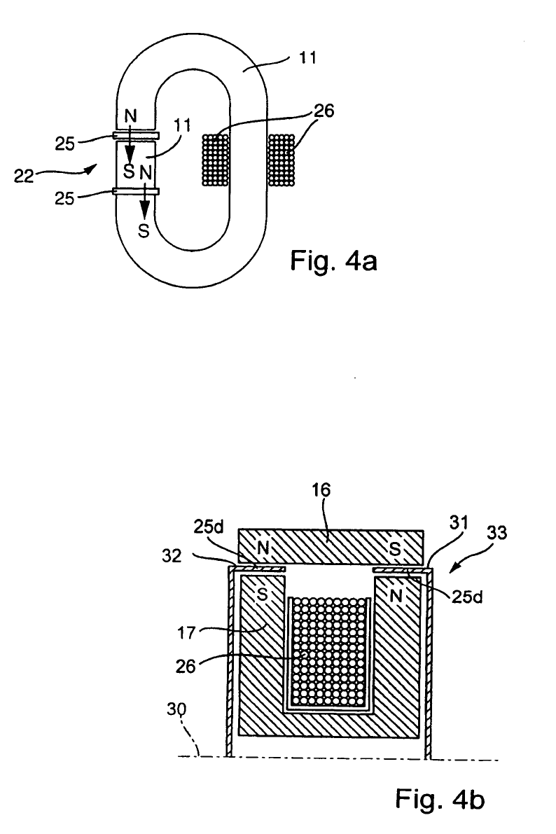

FIGS. 4a, b show a simplified illustration of a magnetic circuit having a multi-part hysteresis device 25d (FIG. 4a) and a sectional illustration of a preferred refinement having pot-shaped hysteresis elements, which are axially spaced apart in relation to the axis of rotation 30, of the hysteresis device 25d (FIG. 4b). In order to avoid unnecessary repetition, in the case of individual elements which have not been described reference is made to the above description in relation to the figures and essentially only the differences will be mentioned in further detail. The magnetic flux can be utilized more effectively. The parts of the multi-part hysteresis device 25d can be arranged on one or more rotors. The above-described pole structure 33 is maintained. The stator 11 comprises two stator parts 16, 17, into which the above-described pole structure 33 is incorporated. The hysteresis elements are in the form of pots, whose pot edge is formed by strips, which rotate about the axis of rotation 30, of the hysteresis device 25d with corresponding magnetic field effect regions 31, 32 associated with the multiple pole structure 33 formed in front of and behind the image plane. In front of, and behind, the image plane, a north pole N is adjacent in each case to a south pole S and a south pole S is adjacent in each case to a north pole N, which is continued by the axis of rotation 33, which also forms the axis of symmetry of the rotor, and forms the corresponding pole structure 33. The hysteresis device 25d is therefore magnetized radially alternately from the inside towards the outside in the case of one pole and from the outside towards the inside in the case of the adjacent pole during the rotation. Since both hysteresis elements are remagnetized on the same radius, they produce the same braking moment in comparison with one another.

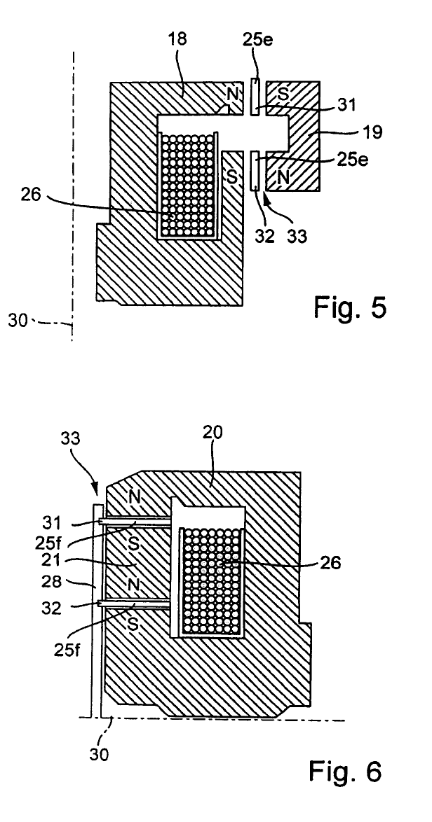

FIG. 5 shows a sectional illustration with a multi-part hysteresis device 25e magnetized in the radial direction having hysteresis elements which are spaced axially apart in relation to an axis of rotation 30. An inner stator part 18 is surrounded concentrically by an outer stator part 19, which is shorter along the axis of rotation 30, and forms a pole structure 33 with the outer stator part 19, which pole structure is formed by two magnetic field effect regions 31, 32 in the hysteresis device 25e. The hysteresis device 25e is in the form of two strips, which rotate about the axis of rotation 30 between the stator parts 18, 19. Since they are positioned on the same radius, they both produce an identical braking moment. The two strips can be arranged on one carrier or else on separate rotating carriers (not illustrated). It is also conceivable to connect the two strips of the hysteresis device 25e.

FIG. 6 shows a sectional illustration with a multi-part hysteresis device 25f magnetized in the radial direction with radially spaced-apart hysteresis elements in the form of strips which rotate on different radii about an axis of rotation 30. The two hysteresis elements are fixed to a rotating carrier 28. Stator parts 20, 21 of a multi-part stator surround a coil 26. The magnetic flux of the multi-part stator is used twice in the hysteresis elements. It is also possible for more hysteresis elements in the form of strips to be provided in order to utilize the magnetic flux more effectively.

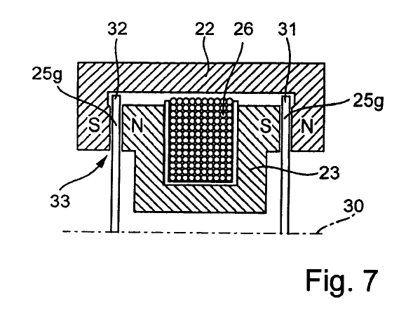

One further preferred hysteresis brake is shown in FIG. 7 as a sectional illustration with a hysteresis device 25g which is magnetized in the circumferential direction and comprises two disks, which are spaced axially apart in relation to their axis of rotation 30. A first stator part 23 is in the form of a pot and contains a coil 26. A second, cover-like stator part 22 is turned over the pot opening and covers a short section of that edge of the first stator part 21 which faces the stator part 22. In this region of overlap, in each case the disks of the hysteresis device 25g rotate. The magnetic flux permeates the two disks in relation to the axis of rotation 30 in the circumferential direction and is therefore used twice. In this arrangement, the mechanical moment of inertia is less than in the case of a radial arrangement. The hysteresis properties of the hysteresis device 25g however can be utilized more effectively in an arrangement in which the hysteresis device 25g has more than two disks which is easily conceivable.

What is claimed is:

1. A valve operating control device hysteresis brake (10) for an internal combustion engine, said hysteresis brake including an electromagnet with a pole structure (33), a hysteresis device (25) rotatably supported about an axis of rotation (30) so as to be movable along a pole structure (33) of an electromagnet forming a magnetic field effect region (31) in the hysteresis device (25) along the pole structure (33), said hysteresis device (25) having, offset in at least one of the axial and the radial directions, at least two magnetic field effect regions (31, 32).

2. The valve operating control device hysteresis brake as claimed in claim 1, wherein the magnetic field effect regions (31, 32) are each established by the pole structure (33) of a common stator (11).

3. The valve operating control device hysteresis brake as claimed in claim 1, wherein the stator (11) is formed from coaxial stator parts (12, 13; 22, 23).

4. The valve operating control device hysteresis brake as claimed in claim 1, wherein the stator (11) is formed from concentric stator parts (14, 15; 16, 17; 18, 19; 20, 21).

5. The valve operating control device hysteresis brake as claimed in claim 1, wherein the hysteresis device (25) comprises a magnetic body in the form of a strip.

6. The valve operating control device hysteresis brake as claimed in claim 5, wherein the hysteresis device (25) has a strip which is disposed rotatably in the circumferential direction within the stator (11).

7. The valve operating control device hysteresis brake as claimed in claim 5, wherein the hysteresis device (25) has two axially offset strips which are disposed rotatably in the circumferential direction within the stator (11).

8. The valve operating control device hysteresis brake as claimed in claim 5, wherein the hysteresis device (25) has two radially offset strips which are disposed rotatably in the circumferential direction within the stator (11).

9. The valve operating control device hysteresis brake as claimed in claim 5, wherein the strip or strips are magnetized in the radial direction in relation to the axis of rotation (30).

10. The valve operating control device hysteresis brake as claimed in claim 1, wherein the hysteresis device (25) comprises a disk-shaped magnetic body.

11. The valve operating control device hysteresis brake as claimed in claim 10, the hysteresis device (25) includes a disk which is supported rotatably within the stator (11).

12. The valve operating control device hysteresis brake as claimed in claim 11, wherein the hysteresis device (25) has two axially offset disks which are disposed rotatably within the stator (11).

13. The valve operating control device hysteresis brake as claimed in claim 10, wherein the disk or disks are magnetized in a circumferential direction in a plane in relation to the axis of rotation (30).

14. The valve operating control device hysteresis brake as claimed in claim 5, wherein the hysteresis device (25) has two axially offset strips which are supported rotatably in the circumferential direction within the stator (11) and are arranged on a common carrier (28).

15. The valve operating control device hysteresis brake as claimed in claim 5, wherein the hysteresis device (25) has two radially offset strips which are supported rotatably in the circumferential direction within the stator (11) and are arranged on a common carrier (28).

16. An arrangement including a valve operating control device hysteresis brake and a camshaft, the valve operating control device being a hysteresis brake (10) having a hysteresis device (25) for a valve operating control arrangement of an internal combustion engine, the hysteresis device (25) being connected to the camshaft via an actuating mechanism for adjusting a phase angle of the camshaft in relation to a crankshaft of the internal combustion engine, wherein the hysteresis device (25) includes, offset in at least one of the axial and the radial direction, at least two magnetic field effect regions (31, 32).
